(19) United States
(12) Patent Application Publication
(10) Pub. No.: US 2007/0216670 A1
(43) Pub. Date: Sep. 20, 2007

(54) Display Device

(76) Inventors: Yasuharu Yatsu, Chiba (JP); Atsuo Osawa, Yokohama (JP); Mikio Shiraishi, Yokohama (JP); Yoshie Kodera, Chigasaki (JP); Tetsu Ohishi, Hiratsuka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/685,791

(22) Filed: Mar. 14, 2007

(30) Foreign Application Priority Data
Mar. 15, 2006 (JP) 2006-070545

(51) Int. Cl. G09G 5/00

(52) U.S. Cl. 345/205

(57) ABSTRACT

The present invention ensures the efficient radiation of heat of a flat display panel without increasing a space outside a display screen of the flat display panel. A periphery of a reinforcing member adhered to a back surface of the flat display panel is folded in an L-shape and a driver IC is brought into contact with the folded portion.

### CLAIM OF PRIORITY

The present application claims priority from Japanese Application JP 2006-070545 filed on Mar. 15, 2006, the content of which is hereby incorporated by reference into this application.

### BACKGROUND OF THE INVENTION

1. Field of the Invention

The present invention relates to a display device which displays a television image or the like using a planar display panel (flat panel: FPD).

2. Description of Related Arts

Recently, with respect to a display device such as a television receiver set, along with the progress of a display device such as a liquid crystal panel (herein after abbreviated as LCD), a plasma display panel (herein after abbreviated as PDP) and an electric-field or electron-emission display (Field Emission Display: herein after referred to as FED), techniques for making the display flat and thin have been rapidly developed.

Such a flat-panel display device such as the LCD, the PDP or the FED adopts the following structure. That is, along an outer periphery of a panel which is formed by adhering two glass substrates on which turn-on scanning electrodes and data electrodes arranged perpendicular to the turn-on scanning electrodes are mounted, terminal portions of the respective scanning electrodes and data electrodes are arranged as a plurality of bundles. Connection terminal portions of flexible cables on which a driver IC for driving panel is mounted are arranged to face the terminal portions by way of an anisotropic conductive film in an opposed manner, and these terminal portions are connected to each other by thermo compression bonding processing.

Among the above-mentioned flat-panel display devices, the FED is a device which enhances a light emission efficiency using a light emission principle similar to a light emission principle of a conventional cathode ray tube (herein after abbreviated as CRT).

The FED is also formed of two glass substrates which differ in functions in the same manner as the PDP. That is, the FED is constituted of a cathode substrate which arranges a large number of electron emission elements (cathodes) thereon, an anode plate which arranges phosphors capable of independently emitting lights of three primary colors consisting of red, green and blue corresponding to the above-mentioned large number of electron emission elements, spacers which allow these two glass substrates to face each other while holding a predetermined distance therebetween, and a frame glass which holds and seals a space formed by two glass substrates and the spacers at a predetermined degree of vacuum.

The cathode substrate and the anode substrate are formed of a glass substrate having a plate thickness of approximately 0.5 mm to 3 mm in the same manner as the PDP. Accordingly, in applying the FED panel to a display device such as a television receiver set, when the anode substrate which forms a display screen is directly exposed on a surface of a housing, there may arise a possibility that the substrate is broken or scattered and a user is injured by a broken piece or the like when an impact force is applied to the display screen from the outside such as striking of the display screen by a child or hitting of an article to the display screen.

The PDP shares the same drawback with the FED. Accordingly, in constituting the display device, several techniques have been proposed including a technique which arranges a transparent protective plate which uses reinforced glass or acryl as a basic material (see patent document 1, patent document 2 or the like, for example), a technique which directly adheres a film having an impact absorption layer to a front surface of a panel (see patent document 3, patent document 4, patent document 5 or the like, for example), and a technique which forms a structural plate substrate which holds a panel from back into the flexible structure (see patent document 6, for example).

Further, in a flat panel display device which uses electron emission elements, to prevent a phenomenon that a background on a viewer side reflected on a display screen is warped due to the deformation of a substrate attributed to an atmospheric pressure when a thickness of the substrate is decreased to make the substrate light-weighted, there has been proposed a technique which forms a layer having light transmitting property on a surface of the substrate of the display panel which is positioned on the viewer side (see patent document 7, for example).

Patent document 1: JP-A-09-149346

Patent document 2: JP-A-2003-084677

Patent document 3: JP-A-2004-181975

Patent document 4: JP-A-2003-248429

Patent document 5: JP-A-2003-140559

Patent document 6: JP-A-2001-345586

Patent document 7: JP-A-2004-335268

### SUMMARY OF THE INVENTION

Along with the realization of finer display cells and the higher packaging density of a driver IC for driving a recent flat panel display device, a demand for outputting signals to a larger number of electrodes with one IC chip is increasing. As a result, a load per one IC chip is increased and hence, the driver IC is liable to increase the generation of heat. Accordingly, to protect the driver IC from the thermal breakdown by rapidly suppressing the generation of heat of the driver IC thus maintaining the driver IC at a fixed temperature or below, there has been a demand for the development of the peripheral structure of the driver IC which can enhance the heat radiation efficiency using a simple technique.

Conventionally, as one means which can efficiently radiate heat of the driver IC without increasing the number of parts, as described in JP-A-10-260641, there has been proposed a method in which a portion of an aluminum reinforcing plate which supports a display panel from a back surface extends from an outer peripheral portion of the display panel, an IC chip is fixed to the portion, and the display panel is adhered to the aluminum reinforcing plate by way of a heat conductive adhesive transfer tape. Further, as described in JP-A-2000-268735, there has been proposed the constitution in which out of a pair of glass substrates which are adhered to each other, one glass substrate extends to the outside of another glass substrate, a heat radiation conductive pattern portion is formed on the extended portion and a driver IC is brought into contact with the conductive pattern and hence, heat generated by the IC chip is directly transferred to the glass substrate and the aluminum reinforcing plate thus enhancing the heat radiation property.

Although these methods respectively possess the heat radiation effects, these methods have following drawbacks.

(1) When the driver IC chip is brought into contact with and is fixed to the outside of an electrode connection terminal on the glass substrate, a distance between a panel display region and an outermost peripheral portion of the panel is increased and hence, it is necessary to adopt the structure in which an outer frame (bezel) of the whole device has a large width whereby the degree of freedom in designing the whole device is lost.

(2) When the flexible cable is bent by 180 degree and is brought into close contact with the aluminum reinforcing plate on the panel backside, an input portion of the driver IC excessively approaches the reinforcing plate and hence, the connection and assembling property of the driver IC with a printed circuit board positioned upstream the driver IC is lowered or a convection of air inside the set hardly reaches an end portion of the aluminum reinforcing plate whereby a drawback that an expected heat radiation effect cannot be obtained or the like remains.

Accordingly, it is an object of the present invention to provide the panel module structure which can overcome the above-mentioned drawbacks of the conventional display device.

Further, in mounting the FED on the display device, it is necessary to enhance the practical breakdown resistance of the panel by adopting the impact absorption means as disclosed in the above-mentioned PDP. The impact resistance of an impact absorption material can be evaluated to a certain extent based on the penetration degree and a Young's modulus as described in detail in patent document 3. In general, however, with respect to the impact resistance of the panel in the set, as described in patent document 3, there has been adopted a method which makes a comparison evaluation by a steel ball falling test in which the presence or the non-presence of the rupture are observed by falling a ball having a predetermined mass in the vertical direction from a panel display screen which is assembled into an actual device by variously changing a height of the steel ball.

According to the investigation carried out by inventors of the present invention using such a testing method, it is found that the FED and the PDP can use the glass substrates having the substantially equal properties and thicknesses and hence, even there exists no large difference with respect to an impact strength of a panel single body, there arises the difference in the impact strength of the whole set depending on the difference of the panel structure. As will be described in detail in embodiments explained later, the PDP adopts the thick plate structure which is formed by adhering two glass substrates close to each other and hence, the face glass substrate and the back glass substrate are integrally deformed with respect to an impact force from the outside. However, since the FED adopts the box-like structure which interposes spacers having a thickness substantially equal to the glass substrate between two glass substrates, the face glass substrate and the back glass substrate are liable to be respectively independently deformed with respect to an impact force from the outside.

Accordingly, when the pure panel single body is placed on a steel surface table and a steel ball falling test is performed, both of the FED and the PDP are controlled by the strength of the glass substrate per se and hence, the difference is hardly generated in rupture strength between them. However, when the glass substrate is assembled into the respective devices, depending on the difference between the respective panel structures, the difference is generated with respect to a propagation state of the impact force, and the deformation state of the face and back glass substrates, and an impact absorption mechanism along with the propagation of the impact force.

Accordingly, in using the display device by assembling the FED panel in the display device, even when the above-mentioned impact absorption technique of the PDP is introduced at random, it is not always possible to obtain an advantageous effect similar to the advantageous effect obtained with respect to the PDP.

Accordingly, when the FED panel is not assembled to the display device such that the structural modification for absorbing the impact brings about an advantageous effect, a manufacturing cost of the display device may be pushed up due to an addition of an undesired structure.

It is another object of the present invention to provide a highly reliable and inexpensive device which can overcome the above-mentioned drawbacks of the display device which uses the FED panel.

The present invention, as a means for overcoming the above-mentioned first drawback, provides the peripheral structure of a driver IC which can enhance a heat radiation efficiency using a simple technique by holding the driver IC at a fixed temperature or below by rapidly suppressing the generation of heat of the driver IC thus protecting the IC from the thermal breakdown. In this structure, an outer peripheral portion of a panel reinforcing member is folded in an L shape, and the driver IC is brought into close contact with the outer peripheral portion, and heat is radiated by a thermal conduction.

The present invention also, as a means for overcoming the above-mentioned second drawback, arranges the first impact absorption structure which can be integrally formed with a scattering prevention film at the time of breaking of the glass substrate on a front surface of the FED panel, and arranges the second impact absorption structure on a surface of or in the inside of a holding plate having rigidity capable of holding the FED panel on a back surface of the panel thus imparting an ability to absorb the most of impact applied to the whole set to the first impact absorption structure.

To explain the summary of the typical inventions among inventions described in this specification, they are as follows.

(1) In a display device which includes a display panel having an envelope which is constituted by allowing a pair of glass substrates which arranges predetermined electrodes on inner surfaces thereof to face each other with a predetermined gap therebetween, a reinforcing member made of a plate material which is adhered to a back surface of the display panel for reinforcing a mechanical strength of a display panel, a flexible printed circuit board, and a driver IC which is mounted on the flexible printed circuit board for driving the electrodes, at least a portion of a peripheral end portion of the reinforcing member is folded, and at least a portion of the driver IC is brought into contact with the folded portion.

(2) In the display device having the constitution (1), at least a portion of the driver IC is brought into contact with the folded portion of the reinforcing member by way of a material which possesses high thermal conductivity.

(3) In the display device having the constitution (2), the material which possesses high thermal conductivity is a silicone resin.

(4) In the display device having the constitution (2), the material which possesses high thermal conductivity is a graphite sheet.

(5) In the display device having any one of the constitutions (1) to (4), at least the folded portion of the reinforcing member is formed of aluminum plate.

(6) In the display device having any one of the constitutions (1) to (4), at least the folded portion of the reinforcing member is formed of a steel plate and plating is applied to a surface of the steel plate.

(7) In the display device having any one of the constitutions (1) to (6), the display device includes a metal plate which is provided for pushing the driver IC to the folded portion of the reinforcing member.

(8) In the display device having the constitution (7), the metal plate which is provided for pushing the driver IC to the folded portion of the reinforcing member is made of a material which differs from a material of the reinforcing member.

(9) In the display device having the constitution (7) or (8), the fin structure for radiating heat is provided to at least a portion of the metal plate which is provided for pushing the driver IC to the folded portion of the reinforcing member.

(10) In a display device which includes a display panel having an envelope which is constituted by allowing a pair of glass substrates which arranges predetermined electrodes on inner surfaces thereof to face each other with a predetermined gap therebetween, and a reinforcing member made of a plate material which is adhered to a back surface of the display panel for reinforcing a mechanical strength of the display panel, the reinforcing member is formed of a steel plate and a surface of the steel plate is covered with a material other than iron.

(11) In a display device using an electron emission display panel which includes a cathode substrate which arranges a large number of electron emission elements thereon in the same plane in a grid array, an anode substrate which arranges phosphors which independently emit lights of three primary colors consisting of red, green and blue within pixels corresponding to the large number of electron emission elements thereon, spacers which allow two glass substrates to face each other while holding a predetermined distance therebetween thus forming a space in which electrons emitted from the cathodes are accelerated, and a frame glass which holds and seals the space formed by two glass substrates and the spacers at a predetermined degree of vacuum, the first impact absorption structure is arranged on a surface of the anode substrate, and the second impact absorption structure is arranged on a surface or in the inside of a holding plate which is adhered to a back surface of the display panel, and the most of impact absorption ability of the whole display device is imparted to the first impact absorption structure.

(12) In the display device having the constitution (11), the first impact absorption structure includes a means for preventing scattering at the time of the occurrence of rupture of the anode substrate.

(13) In the display device having the constitution (11) or (12), the first impact absorption structure contains a silicone-based gel.

(14) In the display device having any one of the constitutions (11) to (13), the second impact absorption structure is formed of a resin material having a function of adhering the display panel and the holding plate to each other.

(15) In the display device having the constitution (14), the resin material of the second impact absorption structure contains an acrylic resin, a urethane resin or a silicone resin.

(16) In the display device having the constitution (12), the means for preventing scattering at the time of the occurrence of rupture of the cathode substrate in the first impact absorption structure has a function of preventing reflection, modifying light or preventing flaws.

(17) In the display device having the constitution (13) or (14), the first impact absorption structure includes a means for preventing scattering at the time of occurrence of rupture of the anode substrate, and the means for preventing scattering includes a function of preventing the reflection, modifying light or preventing flaws.

(18) In the display device having the constitution (11) or (12), the holding plate has the duplicate structure consisting of metal flat plates.

According to one aspect of the present invention, the driver IC can be arranged without requiring a space on a plane of the panel and hence, it is possible to overcome the above-mentioned drawbacks of the display device using the FPD. Further, it is possible to provide a panel module structure which can efficiently radiate heat from the driver IC without restricting a degree of freedom in device design.

According to another aspect of the present invention, by providing the impact absorption structure to the front surface and the back surface of the FED panel and by setting a distribution ratio of the impact absorption abilities of the front surface and the back surface to a predetermined quantity, the present invention can efficiently realize the impact rupture resistance required as the device thus capable of providing the highly reliable display device at a low cost.

### BRIEF DESCRIPTION OF THE DRAWINGS

FIG. 1 is a perspective view showing an appearance of a display device according to the present invention;

FIG. 2 is an exploded perspective view schematically showing the inner constitution of the display device of an embodiment 1 according to the present invention;

FIG. 3 is a cross-sectional view of the display device of the embodiment 1 according to the present invention taken along a line Y-Y in FIG. 2;

FIG. 4 is a cross-sectional view of a display device of the embodiment 2 according to the present invention;

FIG. 5 is an exploded perspective view of a display device of the embodiment 3 according to the present invention;

FIG. 6 is a cross-sectional view of an essential part of a display device of the embodiment 4 according to the present invention;

FIG. 7 is a cross-sectional view of an essential part of a display device of the embodiment 5 according to the present invention;

FIG. 8 is an exploded perspective view schematically showing the inner constitution of a display device of an embodiment 6 according to the present invention;

FIG. 9 is a cross-sectional view of the display device of the embodiment 6 according to the present invention taken along a line Y-Y in FIG. 8;

FIG. 10 is a graph showing an experimental result of the embodiment 6 relevant to impact absorption performance

FIG. 11A is a schematic cross-sectional view of a PDP panel before applying an impact force in performing a steel ball falling test of the PDP panel;

FIG. 11B is a schematic cross-sectional view of the PDP panel after applying the impact force in performing the steel ball falling test of the PDP panel;

FIG. 12A is a schematic cross-sectional view of an FED panel before applying an impact force in performing a steel ball falling test of the FED panel;

FIG. 12B is a schematic cross-sectional view of the FED panel after applying the impact force in performing the steel ball falling test of the FED panel; and

FIG. 13 is a schematic cross-sectional view of a display device of an embodiment 7 according to the present invention.

### DETAILED DESCRIPTION OF THE INVENTION

Hereinafter, best mode for carrying out the invention is explained in conjunction with drawings. Here, in all drawings, parts having common functions are given same symbols, and repeated explanation of the parts which are explained one time is omitted to prevent the cumbersomeness of explanation.

### Embodiment 1

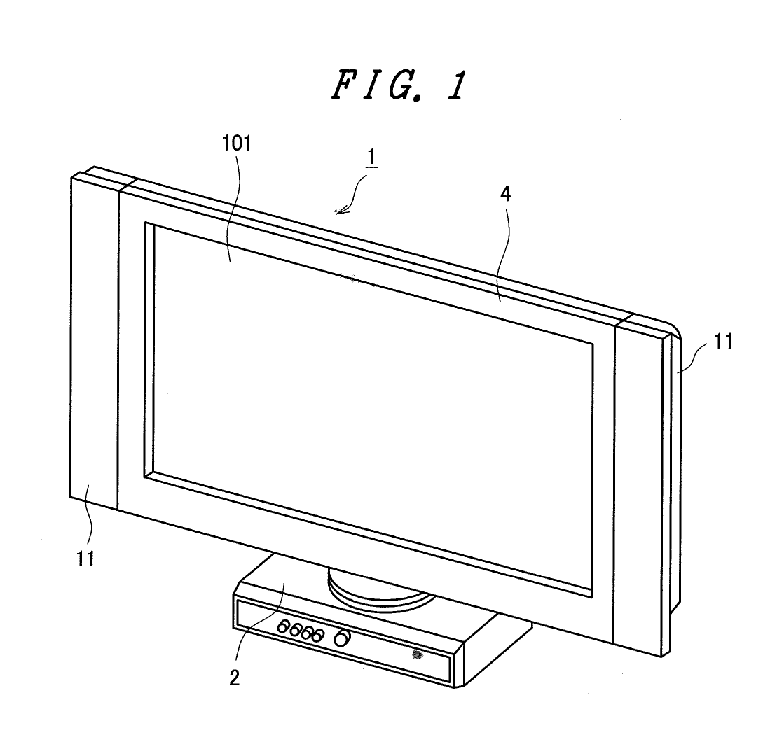

An embodiment 1 according to the present invention is explained in conjunction with FIG. 1 to FIG. 7. The present invention is explained in order from FIG. 1. FIG. 1 is a perspective view showing the schematic appearance of a display device of the embodiment 1 according to the present invention. In FIG. 1, the display device 1 is placed in a state that the display device 1 is supported on a display device support base 2. The display device 1 is used in a mode that an image such as a television image is displayed on a display panel 101 of the display device 1. The display panel 101 of the display device 1 uses a built-in electron emission display (FED). The display of an image on the display device 1 is performed in response to signals from a tuner unit or a video reproducing unit mounted in the inside of the display device support base 2. Further, speakers 11 are provided on the left and right sides of the display device 1 and hence, the display device 1 can also output sounds simultaneously with the image display.

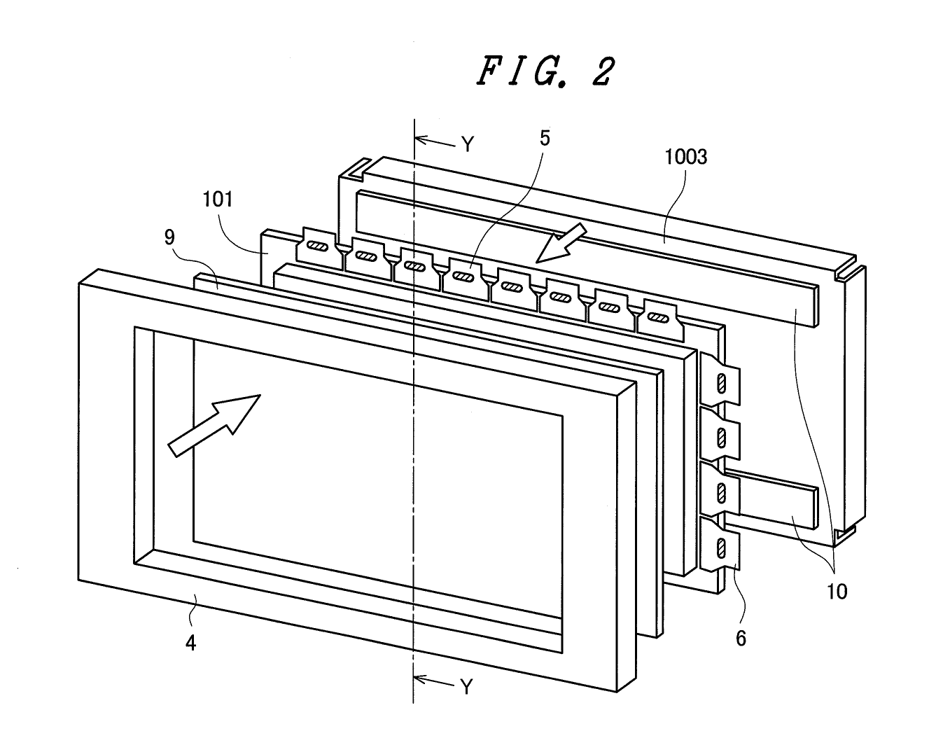

FIG. 2 is an exploded perspective view schematically showing the inner constitution of the display device 1 of an embodiment 1 shown in FIG. 1. An FED panel module which displays an image is arranged in the inside of an outer frame 4 of the housing.

The panel module has the integral structure formed by adhering a filter sheet 9 to a front surface side of the display panel 101 and a panel reinforcing member 1003 which is formed by processing a metal thin plate such as an aluminum plate to the back side of the display panel 101 by way of an adhesive tape 10. Electrode terminal portions (not shown in the drawing) are pulled out from two sides out of four sides of the outer periphery of the panel, and flexible printed circuit boards (herein after abbreviated as FPC) 5 which mount driver ICs for driving data electrodes thereon and FPCs 6 which mount driver ICs for driving scanning electrodes thereon are connected to the electrode terminal portions by thermo compression bonding and are connected to an interface circuit (not shown in the drawing) which is arranged on a back of the reinforcing member 1003.

Here, the reinforcing member 1003 is briefly explained. The general basic structure of the FED is constituted as follows. That is, the FED includes a cathode substrate which forms field emission type electron sources thereon and an anode substrate which applies phosphors to a surface thereof which faces the field emission type electron sources in an opposed manner. These cathode substrate and anode substrate are arranged to face each other in an opposed manner with a predetermined gap therebetween and are hermetically sealed, and a space therebetween is evacuated to vacuum thus forming a vacuum envelope which holds the space in vacuum. Since the inside of the vacuum envelope is held in vacuum, the vacuum envelope can withstand a load attributed to an atmospheric pressure. When a thick glass plate is used for forming the cathode substrate and the anode substrate for this end, a weight of the vacuum envelope is excessively increased. Further, along with the increase of a screen size of the flat type display panel, it is necessary to increase a thickness of the glass substrate corresponding to the increase of the screen size and hence, the weight and a profile size of the flat panel display panel becomes excessively large. To overcome such a drawback, a thin cathode substrate and a thin anode substrate are used and, at the same time, a reinforcing member formed of a plate material made of a material having a mechanical strength and rigidity larger than a mechanical strength and rigidity of glass is adhered to the cathode substrate of the flat type display panel thus realizing the reduction of thickness and the reduction of weight of the display device without decreasing the mechanical strength of display device.

In the panel module, the panel reinforcing member 1003 has longitudinal and lateral sizes substantially equal to longitudinal and lateral sizes of the profile of the display panel 101 and, as shown in FIG. 2, the panel reinforcing member 1003 has a peripheral end portion thereof folded with a predetermined length. In a state that the panel reinforcing member 1003 is adhered to the back of the display panel 101, the folded portion is configured to face the flexible printed circuit boards (FPC) 5, 6 in an opposed manner.

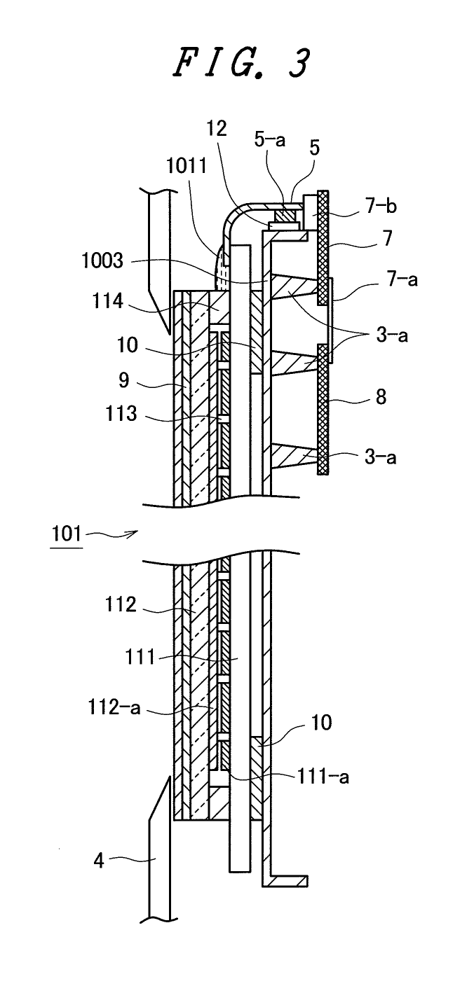

FIG. 3 is a cross-sectional view of the panel module as viewed from the YY direction indicated by an arrow in FIG. 2. The display panel 101 includes a cathode substrate 111 on which a large number of electron emission elements (cathodes) 111-a is formed and arranged in the same plane in a grid array, an anode substrate 112 which includes a phosphor surface 112-a which regularly arranges and forms phosphors which independently emit lights of three primary colors consisting of red, green and blue within pixels defined or partitioned in plane corresponding to the large number of electron emission elements 111-a, spacers 113 which allow two glass substrates 111, 112 to face each other in an opposed manner while holding a predetermined distance therebetween thus forming a space in which electrons emitted from the cathodes 111-a are accelerated toward the anode substrate 112, and a frame glass 114 which maintains the space formed by two glass substrates and the spacers 113 at a predetermined degree of vacuum and hermetically seals the space thus forming an FED panel. Here, a voltage which falls within a range from 2 kV to 15 kV is usually applied between the cathodes 111-a and an anode (not shown in the drawing) on the anode substrate 112.

As has been explained above, the panel reinforcing member 1003 is adhered to the back surface side of the cathode substrate 111 by way of the adhesive tape 10 thus holding the whole display panel 101, while the filter sheet 9 is adhered to a front surface side of the anode substrate 112 thus protecting the display screen.

The FPCs 5 for driving data electrodes which are connected to the electrode terminal portions of the cathode substrate 111 by thermo compression bonding are connected to an IF (interface) substrates 7 which is fixed to a large number of bosses 3-a arranged on the back surface of the reinforcing member 1003 by way of connectors 7-b and is connected to a control circuit board 8 by way of a cable 7-a. Here, a driver IC 5-a on the FPC 5 for driving data electrode is brought into contact with and is fixed to an outer wall which is formed by folding the peripheral portion of the reinforcing member 1003 by way of an adhesive silicone sheet 12. Due to such basic structure, it is possible to ensure an assembling region for the driver IC without forming an unnecessary space outside the display region of the display panel 101 and the terminal pull-out region.

In this embodiment, as a fixing method of the driver IC 5-a, the driver IC 5-a is brought into contact with and is fixed to the outer wall by way of the adhesive silicone sheet having an adhesive property. However, to further suppress irregularities in heat radiation, it may be possible to adopt a technique which mechanically enhances the adhesion between the driver IC 5-a and the reinforcing member 1003.

Here, in FIG. 3, reference numeral 1011 indicates a protective and peel-off preventing coating layer.

### Embodiment 2

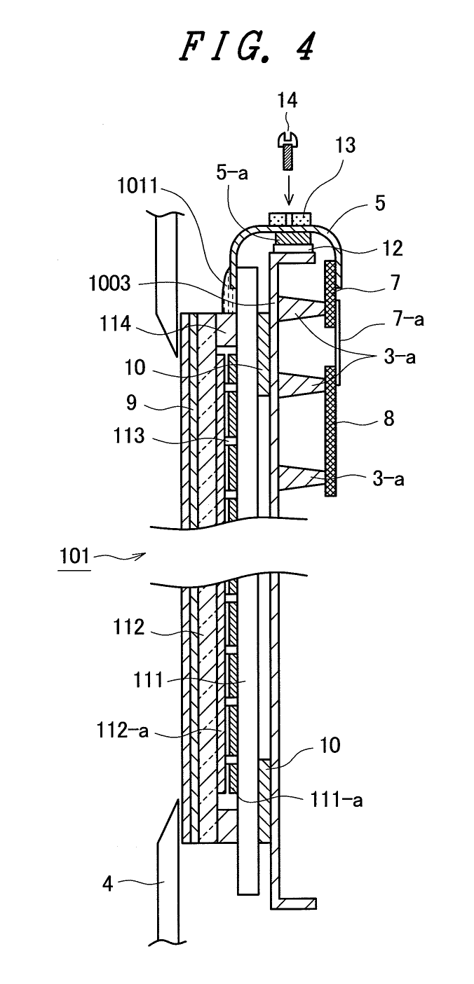

An embodiment 2 of the present invention is shown in FIG. 4. In place of adhering the driver IC 5-a to the outer wall formed by folding the peripheral end portion of the reinforcing member 1003, this embodiment 2 adopts a technique in which the driver IC 5-a is sandwiched between the reinforcing member 1003 and another metal plate 13 from the outside the outer wall of the reinforcing member 1003 and the driver IC 5-a is fixed using screws 14. A silicone sheet 12 which possesses high thermal conductivity is interposed between the reinforcing member 1003 and the driver IC 5-a on a side with which the front surface of the driver IC 5-a is brought into contact and hence, the adhesiveness is enhanced thus providing the structure which can realize the more uniform heat radiation. Further, input terminals of the FPCs 5 for driving data electrode on a side opposite to the panel may be connected to the IF substrate 7 by thermo compression bonding in the same manner as the connection of the FPCs 5 for driving data electrodes to the display panel 101 side thus omitting the use of the connector 7-b whereby the reliability of connection can be enhanced.

Here, in place of the above-mentioned silicone sheet 12, a graphite sheet formed by processing graphite into a sheet shape may be used.

As a material of the reinforcing member 1003, an aluminum plate which is a light-weighted metal plate having high heat conductivity and is suitable for a device such as a PDP which is required to lower the panel temperature. However, a device such as an FED in which the panel temperature is not elevated so much can use a member formed by applying plating to a steel plate which possesses a thermal expansion coefficient closer to a thermal expansion coefficient of the driver IC 5-a. The use of such a member is more suitable from a viewpoint that the difference in thermal strain between the reinforcing member 1003 and the driver IC 5-a as well as between the reinforcing member 1003 and the glass substrate 111 is small.

### Embodiment 3

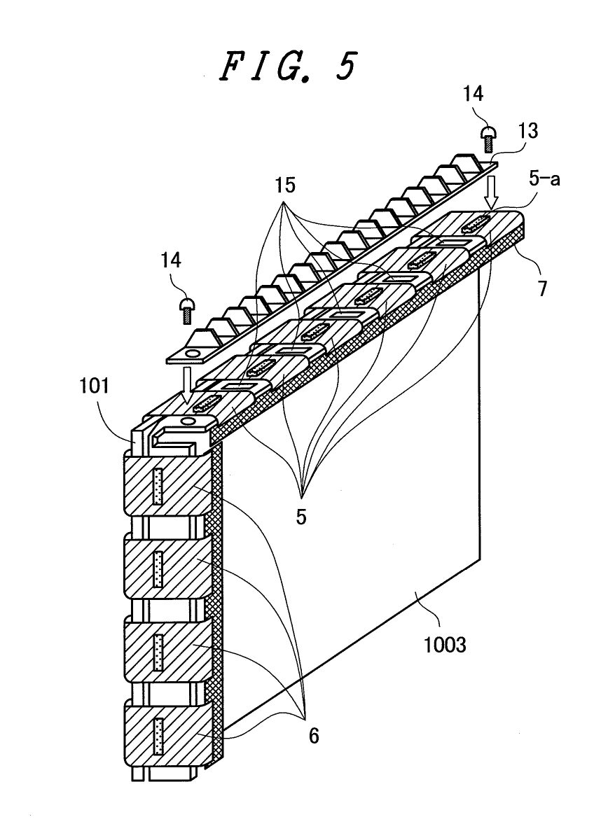

FIG. 5 shows an embodiment 3 which is a developed mode of the embodiment 2. In the embodiment 3, fins for enlarging a heat radiation are a are integrally formed on the metal plate 13 which fixes the driver IC 5-a by sandwiching the driver IC 5-a between the metal plate 13 and the reinforcing member 1003. Due to such constitution, it is possible to enhance the heat radiation efficiency compared to the embodiments 1, 2. Further, it may be possible to generate a convection which flows upwardly along the back surface side of the reinforcing member 1003 by forming spaces having some volume on back surfaces of the display panel 101 and the reinforcing member 1003 and by arranging a printed circuit board while taking the temperature elevation of the printed circuit board into consideration. In this case, it is possible to achieve the heat radiation more effectively by bringing the convection of air into direct contact with the metal plate 13 which forms the fins thereon. Accordingly, ventilation holes 15 for convection are formed in the outer peripheral folded portion of the reinforcing member 1003 at positions corresponding to spaces defined between the FPCs 5 for driving data electrodes thus enhancing the heat radiation effect.

The ICs 5-a on the FPCs 5 for driving data electrodes may be arranged either on the same surface side as the connection terminals or on the back surface side of the connection terminals without any restriction provided that through holes are formed in the inside of a flexible cable.

### Embodiment 4

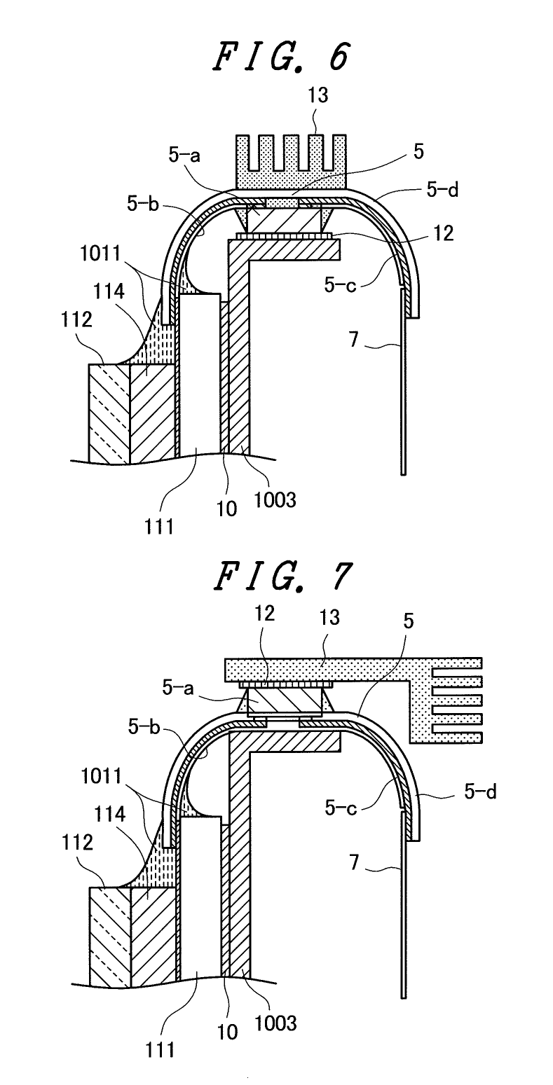

FIG. 6 shows the constitution of an embodiment 4 in which an upper front surface of an IC 5-a on the FPC for driving data electrode 5 is adhered to a side wall of a panel reinforcing member 1003 by way of a silicone sheet 12 and heat radiation fins of a metal plate 13 are projected vertically from the side wall of the panel reinforcing member 1003. In FIG. 6, reference symbol 5-b indicates a cover film, reference symbol 5-c indicates a conductive layer and reference symbol 5-d indicates a base film.

### Embodiment 5

FIG. 7 shows the constitution of an embodiment 5 in which an upper front surface of an IC 5-a on FPC for driving a data electrode 5 is adhered to a metal plate 13 by way of a silicone sheet 12, a lower front surface of the FPC for driving data electrodes 5 is pushed to a panel reinforcing member 1003, and heat radiation fins of the metal plate 13 are projected in parallel with a side wall of the panel reinforcing member 1003. The heat radiation fins formed on the metal plate 13 in FIG. 5, FIG. 6 extend to the outside of the outer peripheral portion of the panel and hence, a profile of a set housing becomes slightly larger than the panel profile whereby the heat radiation fins are extended in the depth direction of the set as shown in FIG. 7 so as to prevent such a drawback.

### Embodiment 6

FIG. 1 and FIG. 8 to FIG. 12B are explanatory views of an embodiment 6 according to the present invention. The explanation is made sequentially from FIG. 1.

FIG. 1 is a perspective view showing a schematic appearance of a display device as an embodiment 6 according to the present invention. In FIG. 1, a display device 1 is placed in a state that the display device 1 is supported on a display device support base 2. The display device 1 is used in a mode that an image such as a television image is displayed on a display panel 101 of the display device 1. The display panel 101 of the display device 1 uses a built-in electron emission display (FED).

The display of an image on the display device 1 is performed in response to signals from a tuner means or a video reproducing means mounted in the inside of the display device support base 2. Further, speakers 11 are arranged on the left and right sides of the display device 1 and hence, the display device 1 can also output sound simultaneously with the image display.

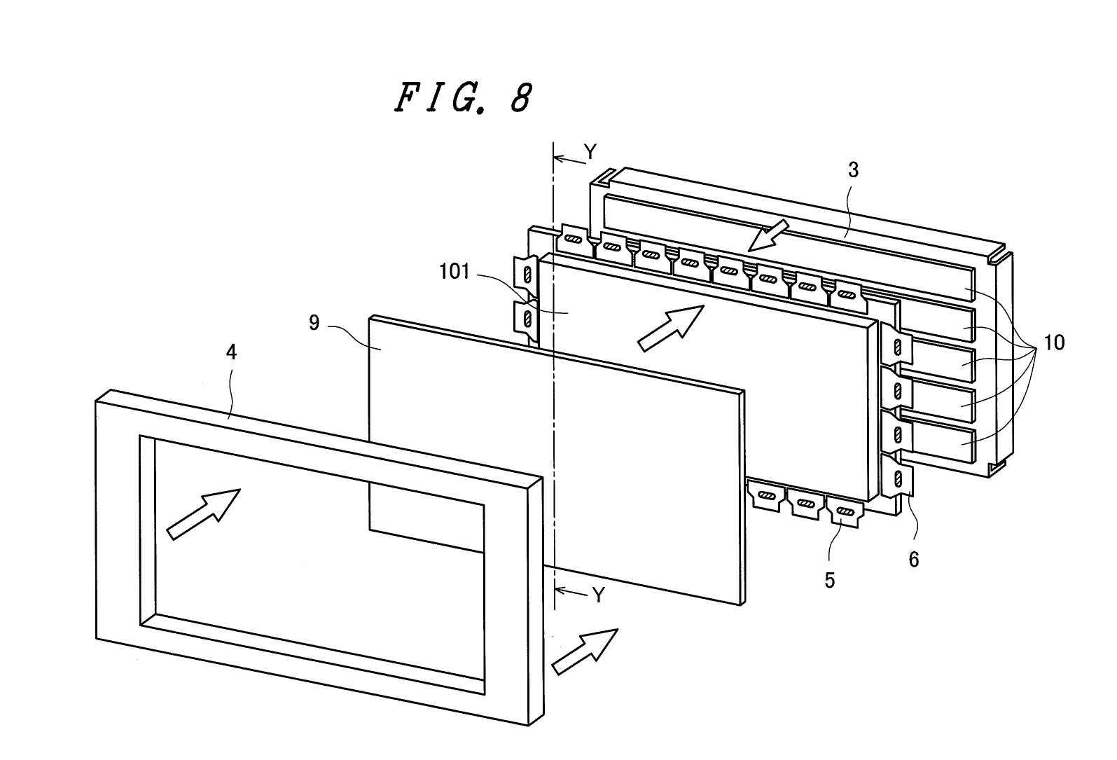

FIG. 8 is an exploded perspective view schematically showing the inner constitution of the display device 1 of the embodiment 6 shown in FIG. 1. A panel module of the FED for displaying an image is arranged in the inside of an outer frame 4 of the housing.

The panel module adopts the integral structure which is formed by adhering a filter sheet 9 to the front surface side of the panel 101 and a holding plate 3 formed of a metal thin plate such as an aluminum plate to the back surface side of the panel 101 by way of an adhesive tape 10. To electrode terminal portions (not shown in the drawing) which are pulled out from four outer peripheral sides of the panel, flexible printed circuit boards (FPC) 5 which mount driver ICs for driving data electrodes thereon and FPCs 6 which mount driver ICs for driving scanning electrodes thereon are connected by thermo compression bonding and are connected to a control circuit (not shown in the drawing) which is arranged on the back surface of the holding plate 3.

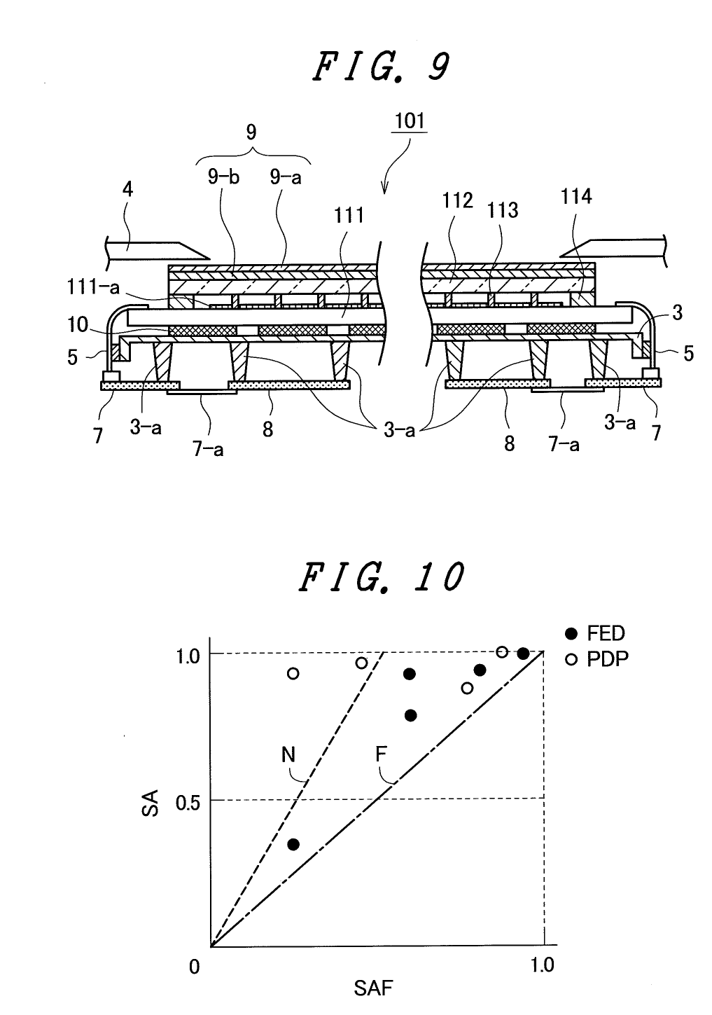

FIG. 9 is a cross-sectional view of the panel module as viewed from the YY direction indicated by an arrow in FIG. 8.

The panel 101 includes a cathode substrate 111 on which a large number of electron emission elements (cathodes) 111-a are formed and arranged in the same plane in a grid array, an anode substrate 112 on which phosphors which independently emit lights of three primary colors consisting of red, green and blue within pixels defined or partitioned are regularly formed and arranged in plane corresponding to the large number of electron emission elements 111-a, spacers 113 which allow two glass substrates 111, 112 to face each other in an opposed manner while holding a predetermined distance therebetween thus forming a space in which electrons emitted from the cathodes 111-a are accelerated toward the anode substrate 112, and a frame glass 114 which maintains the space formed by two glass substrates 111, 112 and the spacers 113 at a predetermined degree of vacuum and hermetically seals the space thus forming an FED panel.

As has been explained above, the panel holding plate 3 is adhered to the back surface side of the cathode substrate 111 by way of the adhesive tape 10 to hold the whole panel 101, and the filter sheet 9 is adhered to the front surface side of the anode plate 112 to protect the display screen.

The FPCs 5 for driving data electrodes which are connected to the electrode terminal portions of the cathode substrate 111 by thermo compression bonding are connected to the control printed circuit board 8 by way of relay substrates 7 which are fixed to a large number of bosses 3-a arranged on a back surface of the holding plate 3 and flat cables 7-a.

When an impact force attributed to falling of a steel ball or the like is applied to a display screen of the panel module having such structure, constitutional element capable of dispersing, absorbing and alleviating the impact force are a filter sheet 9 formed on the front surface of the panel 101 and the adhesive tape 10 formed on the back surface of the panel 101 and a constitutional element capable of distributing bending deformation of the whole panel 101 is the support plate 3 and hence, by combining these constitutional elements, the alleviation of the impact and the enhancement of the rupture resistance can be realized.

The filter sheet 9 is integrally formed of a transparent polymer film 9-a which is exposed from an outermost front surface of the device and prevents scattering of the glass substrate even when the panel is broken and, further, adjusts a light emitting spectrum from the panel 101 and an impact absorption layer 9-b made of silicon gel or the like which exhibits excellent visible-light transmissivity and possesses adhesive property to be closely adhered to the panel 101. The impact absorption ability of the impact absorption layer 9-b can be controlled by changing a thickness of the layer, longitudinal and lateral elastic moduli, a vibration absorption coefficient and a penetration degree.

The adhesive tape 10 is made of a material having viscoelasticity which is formed by imparting adhesiveness to an acrylic resin, a urethane resin, or a silicone resin. The material is suitably selected in view of the panel holding ability and the impact absorption ability of the material under a high temperature and a low temperature. The impact absorption ability can be adjusted by a thickness of the layer and an adhering are a of the adhesive tape 10 with the panel besides the vibration absorption coefficient and the penetration degree which is determined based on the resin material.

A method which fixes a back surface of the panel 101 to the holding plate 3 using a resin-made pressure sensitive adhesive double coated tape 10 has been also popularly adopted by a conventional PDP. However, the PDP exhibits the large elevation of temperature of the panel during the display operation and hence, it is necessary to ensure the favorable and uniform thermal conductivity to the holding plate by closely adhering the whole back surface of the panel to the adhesive tape whereby the selection of material is performed by assigning the most priority to the thermal conductivity characteristic. On the other hand, the FED exhibits the small elevation of temperature of the panel during the operation, in adhering the tape, it may be sufficient to locally adhere the portions of the back surface of the panel to the adhesive tape while ensuring the minimum are a for maintaining a panel holding strength necessary for withstanding the change of environmental conditions such as temperature, moisture or the like of the surrounding of the device. Since the adhesion of the panel 101 receives no restriction with respect to the thermal conductivity, the degree of freedom in the selection of the adhesive tape material and the adhesive are a of the adhesive tape with the panel is increased thus enabling the fine adjustment of the impact absorption force of the adhesive tape layer.

Further, by controlling the bending modulus of the holding plate 3 on the back side of the adhesive sheet 10 by adjusting a thickness of the holding plate 3, the panel can obtain an advantageous effect that an impact which is capable of warping the whole panel can be dispersed and absorbed.

The evaluation of the practical breakdown strength of the device built-in panel using such an impact absorption means is performed by calculating positional energy based on a height which brings about the rupture of the panel in a steel ball falling test and comparing the positional energy with the energy at the time of applying an impact to the panel.

As a specific testing method, the panel 101 in a unit body is placed on a steel machine platen, and a height of the steel ball at which the panel is broken (impact energy) is firstly obtained. Next, the module which is constituted by applying the impact absorption structure to the front surface and the back surface of the panel having the same structural strength is placed on the machine platen in the same manner, and the impact energy at which the panel is broken is obtained. Then the difference between such an impact energy and the breakdown energy of the panel unit body is defined as the whole impact absorption ability and these values are compared with each other.

For example, the impact energy at the time of panel breakdown is obtained by applying the impact absorption structure to the front surface side of the panel and by removing the impact absorption structure from the back surface side of the panel, and the difference between the impact energy and the breakdown energy of the unit body is calculated thus obtaining an impact absorption ability of the panel front surface side. Due to such a method, effects of the individual impact absorption elements with respect to the whole device can be grasped quantitatively.

FIG. 10 shows a result of one experiment indicating the relationship between the impact absorption ability of the panel front surface side and the whole impact absorption ability including the front surface and the back surface of the panel.

In FIG. 10, the panel whole impact absorption ability SA taken along a line of axis of ordinates and the impact absorption ability SAf of the panel front surface taken along a line of axis of abscissas indicate, for the convenience sake, relative values which are normalized by the impact absorption ability which is considered necessary based on the device design. A chained line F in FIG. 10 indicates a value with which the absorption ability on the front surface side of the panel occupies with respect to the total absorption ability. A broken line N in FIG. 10 indicates a neutral line at which the absorption abilities of the panel front surface side and the panel back surface side are balanced with respect to the absorption ability of the whole panel.

Black dots plotted in FIG. 10 indicate the experiment result of the FED panel module and white dots plotted in FIG. 10 indicate the experiment result of the PDP module. Usually, even when the impact absorption structure is applied to the panel front surface side and the panel back surface side independently, the advantageous effect of the impact absorption structure is recognized as the combination of the respective advantageous effects and hence, there is no possibility that the absorption ability of the panel front surface side exceeds the total absorption ability whereby the experiment result is distributed at the left side of the chained line F.

The experiment result shown in FIG. 10 is characterized in that the experiment result of the PDP module widely distributed on the left side of the chained line F, while the experiment result of the FED module is distributed between the chained line F and the broken line N. That is, the PDP module can ensure the reference value necessary for the impact absorption ability of the whole panel by increasing the absorption ability of the panel back surface side even when the absorption ability of the panel front surface side is lowered. On the other hand, in the FED module, when the absorption ability of the panel front surface side is lowered, the absorption ability of the whole panel is lowered and hence, even when the absorption ability of the panel back surface side surface is increased, the impact absorption ability of the whole panel cannot be compensated.

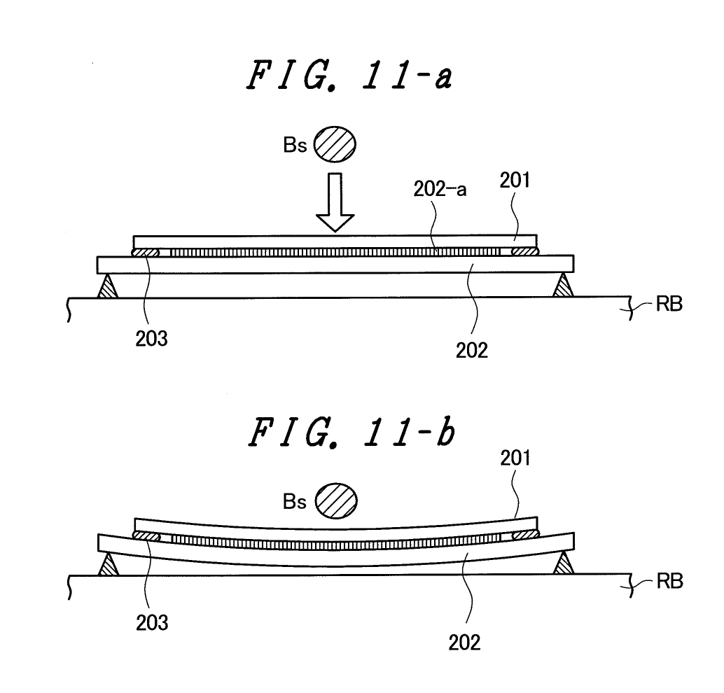

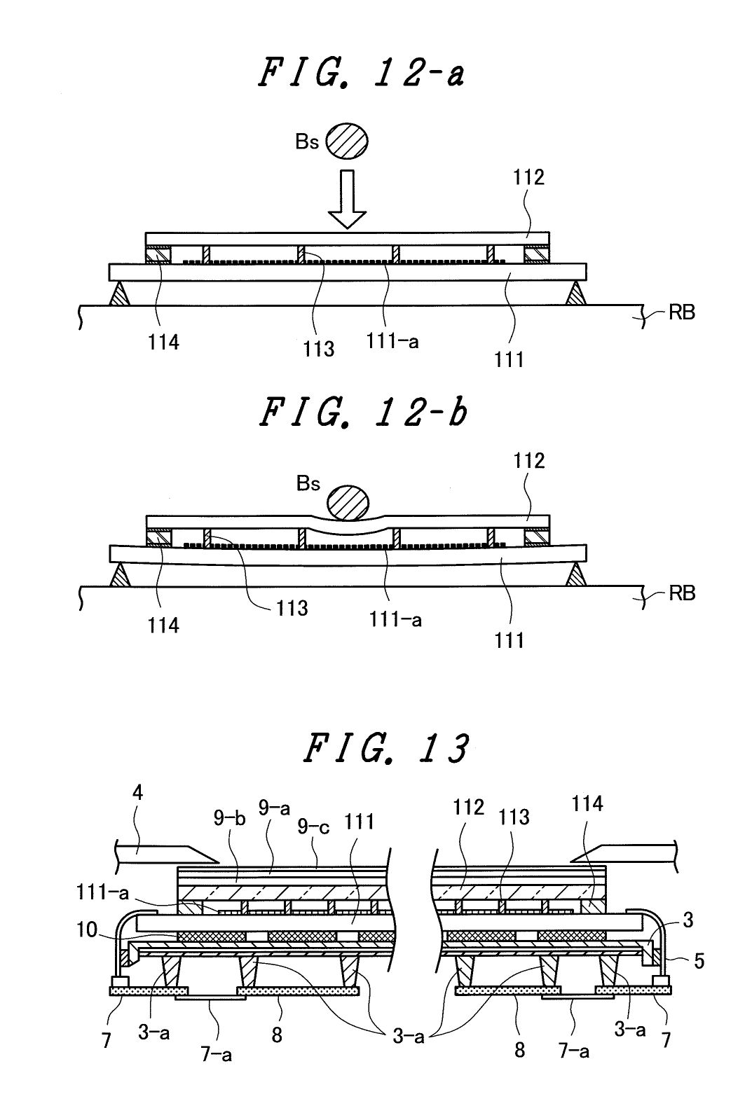

The reason that such a difference occurs even when the same FPD modules are used is explained herein after in conjunction with FIG. 11A, FIG. 11B, and FIG. 12A and FIG. 12B.

FIG. 11A and FIG. 11B are cross-sectional views schematically showing a deformation of the panel which has both end thereof simply supported before and after the application of the impact force at the time of performing the steel ball falling test with respect to the PDP. The PDP adopts the integral structure in which a face plate 201 which stacks electrodes, a dielectric layer and an MgO film on a glass substrate is brought into close contact with a back plate 202 which densely arranges ribs 202-a corresponding to respective light emitting cells on the substantially whole region of a glass substrate. Here, the ribs 202-a have a uniform height of approximately 0.1 mm to 0.2 mm, while the electrodes, the dielectric layer and the MgO film have film thicknesses of approximately 1 to several tens μm, that is, the film thicknesses sufficiently small compared to a thickness of the glass substrate. Due to such a structure, when a steel ball Bs falls on a display screen, as shown in FIG. 11B, the face plate 201 and the back plate 202 are resiliently deformed in the same manner and substantially integrally so as to absorb the impact. Accordingly, as described in the above-mentioned patent document, it is possible to make the structural design which arranges the predetermined impact absorption structure on the front surface, or the back surface or both surfaces of the panel thus increasing the rupture resistance of the glass substrate to a predetermined level. Here, in FIG. 11A and FIG. 11B, reference numeral 203 indicates a sealing material.

On the other hand, the panel structure of the FED is configured as shown in FIG. 12A and FIG. 12B which are cross-sectional schematic views. That is, it is necessary to arrange the above-mentioned anode substrate 112 and cathode substrate 111 having thicknesses of approximately 0.5 mm to 3 mm to face each other in an opposed manner with an inter-surface distance of 0.5 mm to 5 mm (an inter-substrate gap of the PDP being approximately 0.1 mm to 0.3 mm) by means of the spacers 113 so as to form a space in which electrons emitted from electron emitting elements 111-a on the cathode substrate 111 are accelerated. To prevent the panel which is sealed with vacuum from being broken due to an external atmospheric pressure, a necessary minimum number of spacers 113 are locally arranged at predetermined positions in the inside of the panel while avoiding electron sources 111-a at a rate of one spacer per several tens to several hundreds cells.

With the provision of such structure, when a falling impact of the steel ball BS is applied to the front surface of the panel as shown in FIG. 12B, the anode plate 112 is firstly deformed and, thereafter, the impact force is transmitted to the cathode substrate 111 arranged on the back surface of the anode plate 112 by way of the spacers 113 and hence, the deformation states of the anode plate 112 and the cathode substrate 111 differ from each other.

The FED panel does not adopt the structure in which the whole panel consisting of the face plate and the back plate are deformed integrally against the external impact different from the PDP. Accordingly, when the FED panel is assembled into an actual device which differs form the rigid machine platen RB particularly, due to the difference in the respective panel structures, there arise differences with respect to the propagation state of the impact force, the deformation states of the face and back substrates attributed to the impact force, and the impact absorption mechanism thus giving rise to the rupture strength of the panel.

Based on the difference in the impact resistance strength due to the difference in panel structure and the experiment result shown in FIG. 10, according to this embodiment, the above-mentioned parameters are controlled so as to increase the impact absorption ability of the panel front surface side to at least 0.5 or more of the whole panel, and practically 0.70 or more of the whole panel thus optimizing the impact absorption structures of the face panel and the back panel.

### Embodiment 7

FIG. 13 shows an embodiment 7 according to the present invention. In the embodiment 6, the explanation is made by describing the necessary-minimum functions. However, the above-mentioned technique is also applicable to the structure in which the filter sheet 9 on the panel front surface side includes not only the transparent polymer film 9-a and the impact absorption layer 9-b made of silicone gel but also a layer having other function such as a reflection prevention layer which enhances visibility of an image, a hard coating layer which prevents the generation of flaws on a screen or the like formed on the surface 9-c, for example. Further, the silicone gel 9-b may contain an electrolyte thus imparting ion conductivity whereby a function of preventing the charging of a surface of the anode substrate is imparted to the filter sheet. Still further, although the impact absorption effect is reduced compared to the panel front surface side, by forming the holding plate 3 into the duplicate structure made of aluminum or the like thus providing the local flexibility while ensuring the bending modulus is effective for enhancing the total absorption ability.

What is claimed is:

1. A display device comprising:
a display panel having an envelope which is constituted by allowing a pair of glass substrates which arranges predetermined electrodes on inner surfaces thereof to face each other with a predetermined gap therebetween;
a reinforcing member made of a plate material which is adhered to a back surface of the display panel for reinforcing a mechanical strength of a display panel;
a flexible printed circuit board; and
a driver IC which is mounted on the flexible printed circuit board for driving the electrodes, wherein
at least a portion of a peripheral end portion of the reinforcing member is folded, and at least a portion of the driver IC is brought into contact with the folded portion.

2. A display device according to claim 1, wherein at least a portion of the driver IC is brought into contact with the folded portion of the reinforcing member by way of a material which possesses high thermal conductivity.

3. A display device according to claim 2, wherein the material which possesses high thermal conductivity is a silicone resin.

4. A display device according to claim 2, wherein the material which possesses high thermal conductivity is a graphite sheet.

5. A display device according to claim 1, wherein at least the folded portion of the reinforcing member is formed of an aluminum plate.

6. A display device according to claim 1, wherein at least the folded portion of the reinforcing member is formed of a steel plate and plating is applied to a surface of the steel plate.

7. A display device according to claim 1, wherein the display device includes a metal plate which is provided for pushing the driver IC to the folded portion of the reinforcing member.

8. A display device according to claim 7, wherein the metal plate which is provided for pushing the driver IC to the folded portion of the reinforcing member is made of a material which differs from a material of the reinforcing member.

9. A display device according to claim 7, wherein the fin structure for radiating heat is provided to at least a portion of the metal plate which is provided for pushing the driver IC to the folded portion of the reinforcing member.

10. A display device comprising:
a display panel having an envelope which is constituted by allowing a pair of glass substrates which arranges predetermined electrodes on inner surfaces thereof to face each other with a predetermined gap therebetween; and
a reinforcing member made of a plate material which is adhered to a back surface of the display panel for reinforcing a mechanical strength of the display panel, wherein
the reinforcing member is formed of a steel plate and a surface of the steel plate is covered with a material other than iron.

11. A display device using an electron emission display panel, the electron emission display panel comprising:
a cathode substrate which arranges a large number of electron emission elements thereon in the same plane in a grid array;
an anode substrate which arranges phosphors which independently emit lights of three primary colors consisting of red, green and blue within pixels corresponding to the large number of electron emission elements thereon;
spacers which allow two glass substrates to face each other while holding a predetermined distance therebetween thus forming a space in which electrons emitted from the cathodes are accelerated; and
a frame glass which holds and seals the space formed by two glass substrates and the spacers at a predetermined degree of vacuum, wherein
the first impact absorption structure is arranged on a surface of the anode substrate, and
the second impact absorption structure is arranged on a surface or in the inside of a holding plate which is adhered to a back surface of the display panel, and the most of impact absorption ability of the whole display device is imparted to the first impact absorption structure.

12. A display device according to claim 11, wherein the first impact absorption structure includes a means for preventing scattering at the time of the occurrence of rupture of the anode substrate.

13. A display device according to claim 11, wherein the first impact absorption structure contains a silicone-based gel.

14. A display device according to claim 11, wherein the second impact absorption structure is formed of a resin material having a function of adhering the display panel and the holding plate to each other.

15. A display device according to claim 14, wherein the resin material of the second impact absorption structure contains an acrylic resin, a urethane resin or a silicone resin.

16. A display device according to claim 12, wherein the means for preventing scattering at the time of the occurrence of rupture of the cathode substrate in the first impact absorption structure has a function of preventing reflection, modifying light or preventing flaws.

17. A display device according to claim 13, wherein the first impact absorption structure includes a means for preventing scattering at the time of occurrence of rupture of the anode substrate, and the means for preventing scattering includes a function of preventing the reflection, modifying light or preventing flaws.

18. A display device according to claim 11, wherein the holding plate has the duplicate structure consisting of metal flat plates.
